(19) United States
(12) Patent Application Publication
(10) Pub. No.: US 2006/0075109 A1
(43) Pub. Date: Apr. 6, 2006

(54) Methodology, system and computer readable medium for masking network connection data

(76) Inventor: Matthew Hartley, Alexandria, VA (US)

Correspondence Address: MARTIN & HENSON, P.C., 9250 W 5TH AVENUE, SUITE 200, LAKEWOOD, CO, 80226, US

(21) Appl. No.: 10/952,238

(22) Filed: Sep. 28, 2004

(51) Int. Cl. G06F 15/16

(52) U.S. Cl. 709/227

(57) ABSTRACT

A method system and computer-readable media are provided for manipulating the presentation of network connection data, in response to a request from a user space application, on a computer running a Solaris operating system and utilizing a STREAMS sub-system. The method involves a determination of whether a getmsg system call that is processed by the operating system pertains to a selected stream module of interest. If so, data fields corresponding to the network connection are selectively modified and passed to the user space application.

### BACKGROUND OF THE INVENTION

The present invention broadly relates to the field of network communication systems. The present invention also concerns the field of operating system development and, particularly, implementations at the kernel processing level of a computer's operating system to control the presentation of network connection information.

For a variety reasons, it may be desirable to ascertain the status of network connections on a computer system and, depending on the operating system, a variety of network troubleshooting utilities may be available. One widely available utility for use with many OS platforms is netstat, a command line utility often used to debug clients and servers in order to troubleshoot connections over a TCP/IP network. To use the tool in its most basic form, one need only open a command prompt window and enter the netstat command, which will generate a listing of current TCP/IP connections. The information presented on the screen typically includes the protocol, local and foreign addresses, and the connection state. Different parameters can also be included on the command line to display addition connection data.

It is sometimes, instead, desirable to mask or hide network connection data rather than revealing it accurately, or at all. For example, invisible connections created by users can be used to allow programs to download information without visibility to a set of users on a specific system. Hiding connection data can also be useful to secure certain important connections so that unauthorized users cannot discern the information. Even still, hiding network connection data can reduce the complexity of the output for programs, such as netstat, making it easier for system administrators to perform daily tasks.

Historically, network connection data has been hidden through direct replacement or manipulation of the user program's executable binary code intended to display connection information. By modifying user space tools like netstat, kernel functions, structures and data are not affected in any way. While performing the manipulation in user space is relatively easy, it is necessary that every program capable of displaying connection information be modified in such a manner for the hiding to be effective. Understandably, this can be quite an arduous task.

Only one type of kernel implementation is known for concealing network connection data for Solaris. While other kernel modifications have been used for other operating systems to manipulate netstat types of data, they have utilized different, less powerful approaches. A presentation by Job De Haas was at one time available at the web address http://www.itsx.com/hal2001/solkern/index.html, although it is believed that the code has since been removed from the ITSX website. This only known Solaris kernel implementation for hiding network connection data was in the form of a loadable kernel module (LKM) and will be referred to as the “Job De Haas LKM”. The Job De Haas LKM only supported the TCPv4 protocol, and was only capable of hiding all connections to a specific port, as identified by the user prior to compiling. Thus, to make any changes to the single port designated for hiding, it became necessary to recompile the code and load it into the kernel each time. Moreover, the kernel implementation was non-modular in that it was written specifically for, and functioned solely with, Sun Microsystems' Solaris 2.7 OS kernel (also known and hereafter referred to as “Solaris 7”). The Job De Haas LKM utilized a specific interface as a “hook” into a suitable place in the network driver STREAMS sub-system, whereupon suitable data could be manipulated to effectuate the hiding of the network connection information on a particular port, such as TCP/IP port 80. It was discovered that the particular streams module for use as the hook point was identified in the Solaris 7 OS by module ID No. 5607.

Although the Job De Haas LKM was somewhat effective for it limited purpose, it accomplished little more than illustrating the demonstrable capability of concealing network connection data. Indeed, it has been demonstrated that this prior implementation is not very portable because it adopted a hard coded approach for the streams module ID number which has since been changed, for example, in the more recent Solaris 9 OS.

Accordingly, there remains a need to provide a new and improved kernel-level implementation for manipulating network connection data so that it can be either masked or hidden, and particularly one which allows for greater portability of the code across the variety of Solaris operating systems, including the current Solaris 9 OS. A further need still remains to provide such an implementation which allows more robust manipulation of the data, while also being more modular in the sense that new features can be added with relative ease. The present invention is directed to meeting these needs among others.

### BRIEF SUMMARY OF THE INVENTION

The present invention provides methodologies, a computer-readable medium and a system for use in manipulating the presentation of network connection data. In its various forms, the present invention is particularly suitable for use on a computer running a Solaris operating system which utilizes a STREAMS sub-system, such as kernel version Solaris 2.7 of higher, whereupon network connection data can be manipulated when requested by a user space application, such as netstat.

According to one exemplary embodiment of the computerized method, a variety of actions occur in response to a getmsg system call from the user space application. Namely, the getmsg system call is processed by the operating system and the file descriptor returned by the system call is retrieved. A determination is then made as to whether the retrieved file descriptor corresponds to a device which uses a stream head. If so, queues within the stream head are analyzed to ascertain whether any encountered queue relates to a stream module of interest. If so, then one or more modification(s) can be made to selected data within the encountered queue which corresponds to network connection characteristics of the computer system, thus generating modified network connection data. This modified network connection data is then passed to the user space application for further processing. A somewhat broader implementation of this methodology entails determining, for each respective getmsg system call that is processed by the operating system, whether it pertains to a selected stream module of interest and, if so, selectively modifying data fields corresponding to network connection characteristics of the computer system, whereupon the modified network connection data is passed to the user space application.

A still further exemplary embodiment of the computerized method of the present invention comprises identifying a responsible system call function within the operating system that is called by the associated user space application to retrieve network connection data. Once the responsible system call function has been identified, a determination is made each time it is processed by the operating system as to whether there is an associated stream module of interest which contains unmodified network connection data characteristic of the computer's network connection status. If so, the unmodified network connection data can be selectively altered to produce modified network connection data to be passed to the user space application. Advantageously, the present invention is suitable for use with a variety of Solaris operating systems, including Solaris kernel version numbers 2.7, 2.8 and 2.9. The stream module of interest is identified by a unique module identifier. Within Solaris 2.7, the unique module identifier is 5607. In Solaris 2.8 and 2.9, the unique module identifier has been found to be 5707.

In order to determine whether the file descriptor returned by the getmsg system call corresponds to a device which uses a stream head, a determination is made whether the file descriptor's associated file structure has a vnode object which points to a stream head. Read queues within the stream head are then sequentially analyzed to ascertain whether any encountered read queue has an associated information structure containing a module identifier corresponding to 5607 for the Solaris 2.7 OS, or 5707 for Solaris 2.8 OS and 2.9 OS. If this in found to be the case, then selected data within the encountered read queue can be modified by clearing network connection information for a plurality of data fields within the queue's information structure. These data fields may be one or more of a connection state data field, a local address data field, a remote address data field, a local port data field, and a remote port data field. Preferably also, data modification can entail setting of the connection entry status to an “idle” state. Advantageously, the invention can be implemented on a computer adapted to communicate according to a plurality of network communication protocols, such as TCPv4, TCPv6, UDPv4 and UDPv6, so that suitable modifications can be made irrespective of the particular protocol employed.

The present invention also provides a computer-readable medium which comprises a loadable kernel module (LKM) having executable instructions for performing the above operations. Indeed, a method is contemplated which comprises loading such a kernel module into the operating system's, and modifying the system call table to redirect each system call intended for getmsg to this new kernel module. Finally, the present invention also provides a system for selectively manipulating presentation of network connection data when requested by a netstat utility. The system comprises: (1) a storage device; (2) a Solaris operating system of a selected kernel version which utilizes a STREAMS sub-system and which supports getmsg system calls; (3) a processor which is programmed to selectively modify information within network connection data fields each time a respective getmsg system call pertains to the selected stream module of interest, and to pass the modified network connection data to the user space application; and (4) and output device for presenting the modified network connection data.

These and other aspects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 diagrammatically illustrates the infrastructure of a typical, and simplified, STREAMS sub-system as known in the prior art;

FIG. 2 diagrammatically represents a procedure for loading and unloading the loadable kernel module of the present invention;

FIG. 3(a) illustrates a typical operating system, such as Solaris, and its system call interface prior to insertion of the loadable kernel module;

FIG. 3(b) illustrates the operating system of FIG. 3(a) after the kernel module of the present invention has been loaded;

FIG. 4 illustrates a diagram of an exemplary general purpose computer system that may be configured to implement aspects of the present invention;

FIG. 5 represents a high level flow diagram for computer software which implements the functions of the loadable kernel module of the present invention; and

FIGS. 6(a)-6(c) collectively comprise a more detailed flowchart for computer software which implements the functions of the loadable kernel module.

### DETAILED DESCRIPTION OF THE INVENTION

The present invention relates to techniques for use in Sun Microsystems' Solaris operating systems to mask or hide network connection information from administrative network commands such as netstat, local protocol connection analyzers, or network administrative tools. The techniques described herein allow a user the ability to mask or hide information including local address and port, remote address and port, protocol and protocol version, the send and receive window sizes and queues, and the state of a connection. The techniques described herein are particularly suitable for a computer system running any of the Solaris 7, 8 or 9 operating system (OS) kernels, and can be suitably tailored for use with the TCPv4, TCPv6, UDPv4 and UDPv6 protocols.

All connection data is manipulated in kernel space, or in other words, inside the running operating system. While the present invention adopts a kernel-level approach, as with the Job De Hass LKM discussed in the Background section, it uses both a different hook point and a dynamic approach that functions on modern Solaris versions, among other differences. Performing the modification and kernel space is important, as it changes the view of network connection information to all users and programs simultaneously and at a single point. While it is not easy to develop technology to perform these operations in the kernel, it greatly reduces the complexity and degree of work to implement these methods and procedures.

In the following detailed description, reference is made to the accompanying drawings which form a part hereof, and in which is shown by way of illustrations specific embodiments for practicing the invention. The leading digit(s) of the reference numbers in the figures usually correlate to the figure number; one notable exception is that identical components which appear in multiple figures are identified by the same reference numbers. The embodiments illustrated by the figures are described in sufficient detail to enable those skilled in the art to practice the invention, and it is to be understood that other embodiments may be utilized and changes may be made without departing from the spirit and scope of the present invention. The following detailed description is, therefore, not to be taken in a limiting sense, and the scope of the present invention is defined by the appended claims.

Various terms are used throughout the description and the claims which should have conventional meanings to those with a pertinent understanding of operating system development and software programming. While the description to follow may entail terminology which is perhaps tailored to certain OS platforms, such as Solaris, or programming environments, the ordinarily skilled artisan will appreciate that such terminology is employed in a descriptive sense and not a limiting sense. Where a confined meaning of a term is intended, it will be set forth or otherwise apparent from the disclosure.

Aspects of the present invention require a suitable understanding of the STREAMS-based architecture which is a feature of UNIX System V in general, and the Solaris implementation in particular. The STREAMS sub-system provides a framework for data transfer among UNIX system services, including network communications and their terminal sub-system. More particularly, STREAMS provides a standardization for dynamically building and passing messages up and down a protocol stack such as TCP/IP. STREAMS represent a collection of the system calls, kernel resources and kernel utility routines for creating, using and dismantling a stream. STREAMS provide a full-duplex connection between a process in user space and a driver in kernel space. In this context the driver can be either a hardware driver or a pseudo-device driver (e.g., a software driver). STREAMS utilizes message prioritization and provides a mechanism to layer or “push” modules on top of each other at runtime. This is quite useful for implementation of network protocols that have a layered architecture, such as those following the OSI model.

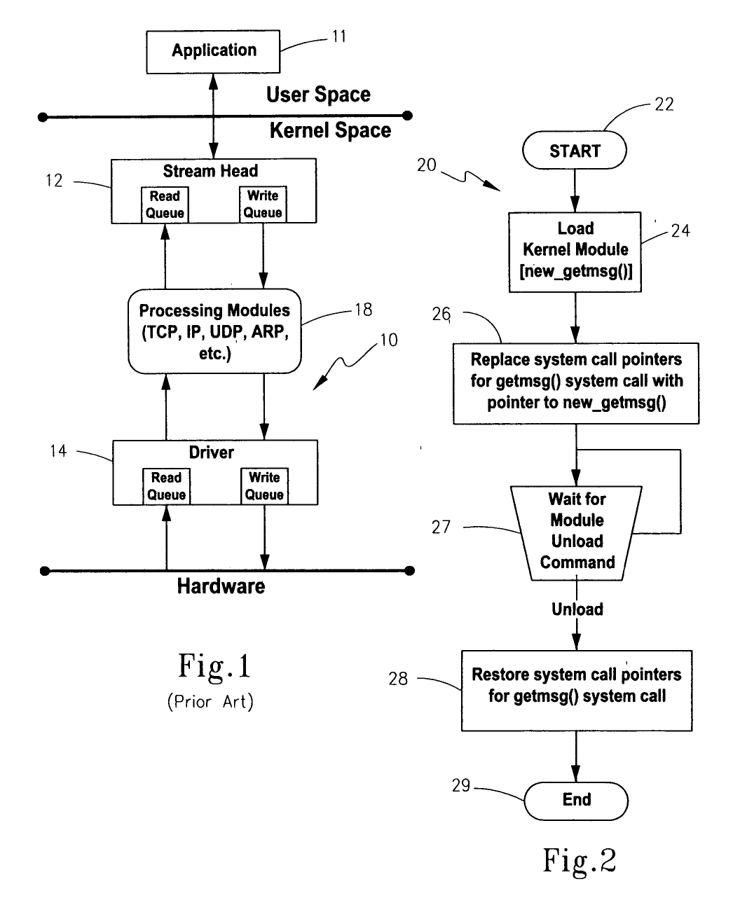

Prior art FIG. 1 diagrammatically illustrates the infrastructure of a simplified STREAMS sub-system interface. The STREAMS sub-system architecture is well understood and informative resources which describe it, as well as UNIX network programming in general, include Rago, S. A. “UNIX System V Network Programming”, Addison-Wesley, Reading, Mass. (1993) and AT&T, “Unix System V Release 3.2 STREAMS Programmer's Guide”, Englewood Cliffs, N.J., Prentice Hall (1989). Other more generic STREAMS references include “Unix System V Release 4: Programmer's Guide: Streams (AT&T Unix System V, Release 4. System Programmer's Series), by AT&T, Prentice Hall PTR (Jun. 18, 1993); and “UNIX Internals: The New Frontiers”, by Uresh Vahalia, Prentice Hall, 1^{st} ed. (Oct. 23, 1995).

Accordingly, FIG. 1 is provided for illustrative purposes only. In FIG. 1, Stream 10 passes data in the form of messages between the stream head 12 and a driver 14. The stream head 12 determines whether the data transfer is network based (IP, ARP, etc.), or terminal based (i.e. TTY). Regardless of the origin, the inner sub-system communication mechanism remains the same. An application process 11 that requires the STREAMS sub-system 10 makes a system call from user space.

Messages are the means of transferring data and communicating within a stream. Once the communication has ceased, the stream head 10 is torn down and the memory that was allocated from the stream is freed for later use by the kernel. A STREAMS message contains data, status or control information, or a combination of both. Each message includes a specified message type indicator and identifies its contents. Data sent to the driver 14 from the user process 11 is packaged into STREAMS messages for transmission. Messages that are passed from the stream head 12 toward the driver 14 are said to travel downstream while those messages passed in the reverse direction travel upstream. Downstream messages arriving at stream head 12 are copied from user buffers and processed by the stream head.

A process can dynamically add or remove intermediate processing modules between the stream head 12 and driver 14. In FIG. 1, a set of processing modules 18 is depicted for illustration, with it being understood that each module performs intermediate transformations of messages passing between the stream head 12 and the driver 14. As well known, pairs of QUEUE structures (read and write) in order to implement the bidirectional and symmetrical attributes of the Stream. Each QUEUE can contain one or more messages which are dynamically attached to the QUEUE on a linked list (message queue) as well as processing procedures.

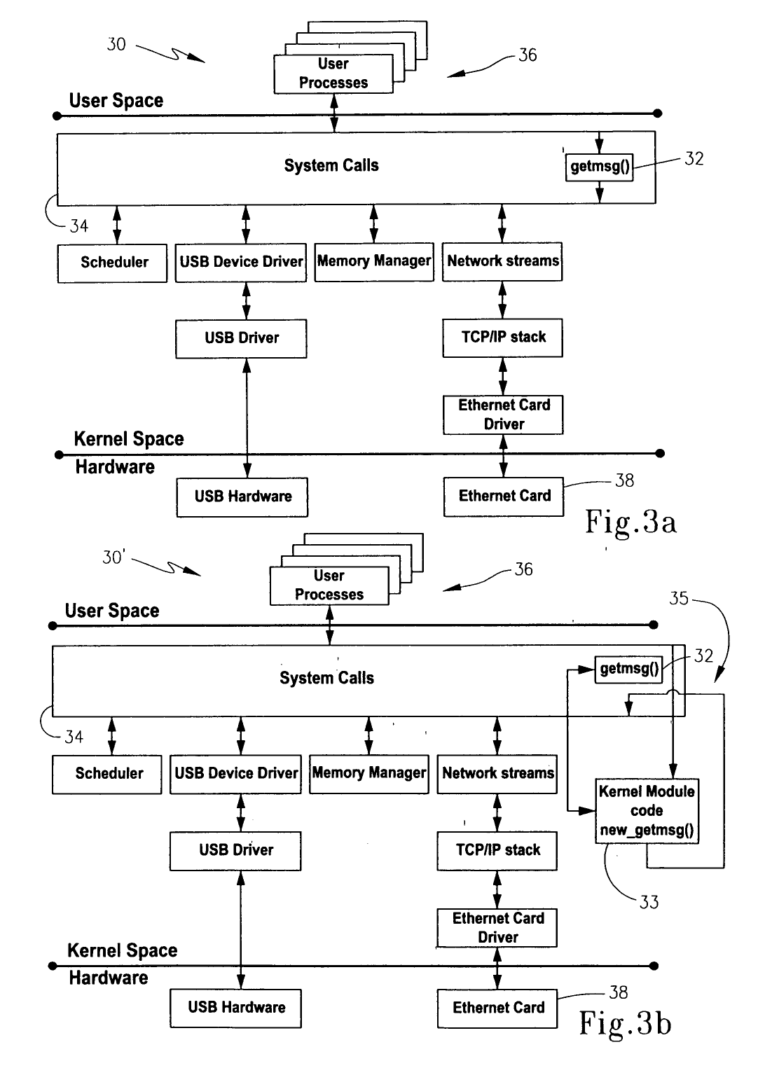

FIG. 2 diagrammatically represents a procedure 20 for implementing the invention through the use of a loadable kernel module (LKM). Following start 22 the kernel module, referred to as new_getmsg( ), is loaded at 24. At 26, all system call pointers for the original getmsg( ) system call are replaced with the pointer to new_getmsg( ). The operating system then waits at 27 for a module unload command from the user. If this command is received, the system call pointers are restored at 28 and procedure 20 ends at 29. FIG. 2, thus, describes in general terms a procedure for utilizing an LKM implementation for the present invention, which procedure is well understood to those of suitable skill level. Moreover, it should be recognized, that the principle aspects can be implemented in a variety of manners, such as through direct inclusion of source code into the kernel itself, as opposed to one or more modules which can be linked to (and unlinked from) the kernel at runtime.

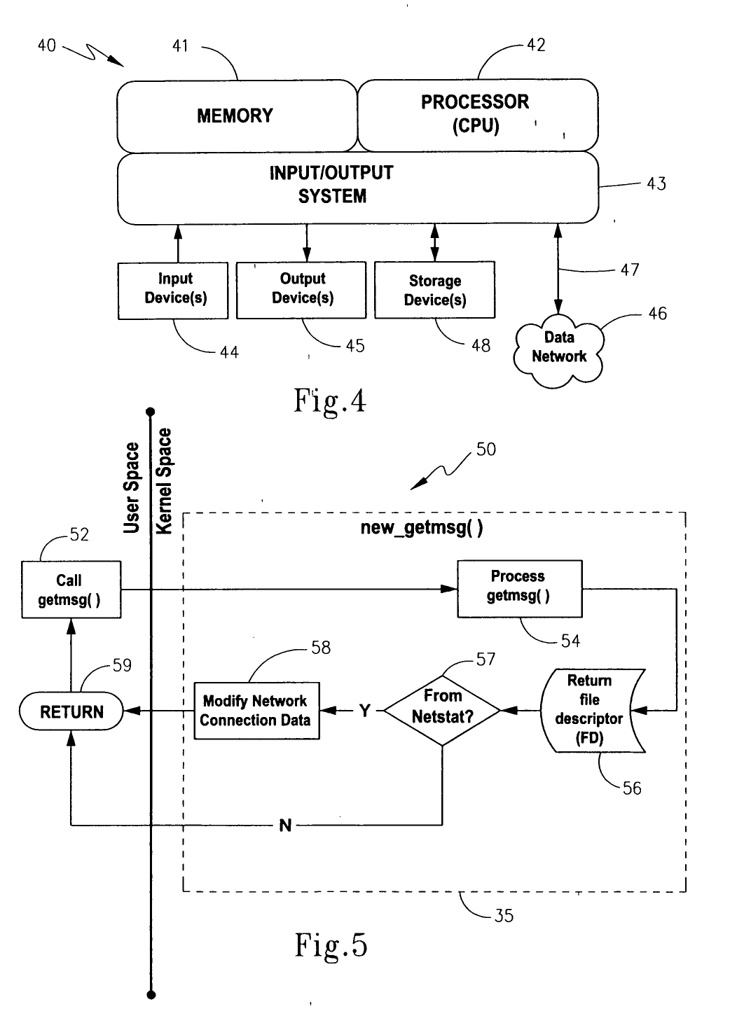

In FIG. 3(a), a diagram 30 is provided to depict a representative operating system prior to insertion of the LKM. Here, the operating system has the original getmsg system call 32 associated with the system call interface 34. Many other system calls are, of course, available, but it is to be understood that the diagram is somewhat simplified for explanatory purposes. Any one of a plurality of user processes/user applications 36 which require services of the kernel communicate with it via system call interface 34. An example of such a user process which is pertinent to the teachings of the present invention is netstat which utilizes the getmsg system call function 32 to request network connection data from the kernel. Via this interfacing, then, the kernel can acquire this information from hardware, such as the Ethernet card 38, and cause responsive data to be passed to the associated user process via system call interface 34, all as known in the art.

FIG. 3(b) shows the data flow which occurs when a custom LKM according to the present invention is loaded into the kernel's memory, as contemplated by the procedure in FIG. 2. In diagram 30′, the associated user process 36 now bypasses the original getmsg within the system call interface 34 and instead is pointed to the code 33 [new_getmsg( )] associated with LKM 35, which has now been injected into the kernel. Code for the LKM actually calls the original getmsg system call function 32 and, based on data returned by it, implements processing to manipulate network connection data if necessary. LKM 35 then communicates any modified network connection data back to the associated user process 36 in a known manner. It can, thus, be appreciated that the present kernel implementation redirects all system calls for getmsg 32 to the custom LKM 35 in a manner which is transparent to the user space process 36.

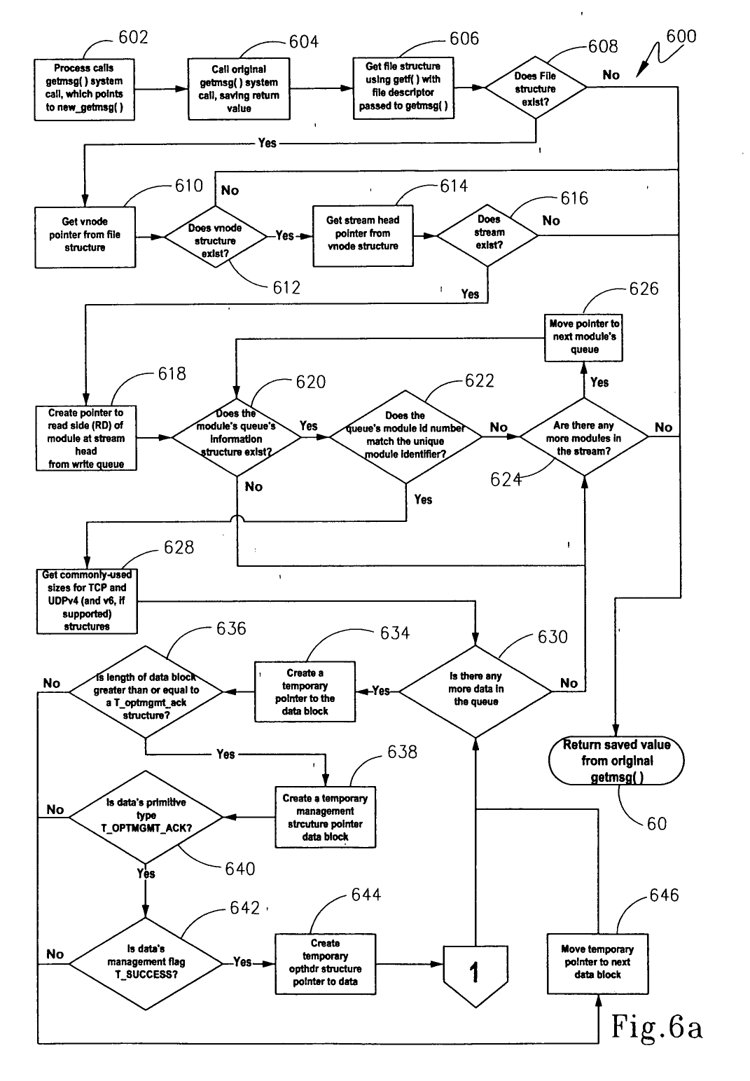

Aspects of the present invention may be implemented on a user's/client computer 40, such as shown in FIG. 4. More particularly, the general purpose computer 40 may be used to execute applications comprising computerized systems constructed in accordance with the present invention, and may be adapted to execute in the well-known Solaris 7 or higher operating system (OS) environments. An explanation of the Solaris family of operating systems is beyond the scope of this document and the reader is assumed to be either conversant with its kernel architecture or to have access to conventional textbooks on the subject, such as “Solaris Internals: Core Kernel Architecture”, by Jim Mauro and Richard McDougall, Sun Microsystems Press, Prentice Hall PTR, 1^{st} ed. (Oct. 2, 2000).

Among other things, computer system 40 comprises a memory 41, central processing unit (CPU) 42, and an I/O system 43. The memory may include volatile memory such as static or dynamic RAM and non-volatile memory such as ROMs, PROMs, EPROMs. Various types of storage devices 44 can be provided as more permanent storage areas. Such devices may be a permanent storage device such as a large-capacity hard disk drive, or a removable storage device such as a floppy disk drive, a CD-ROM drive, a DVD-ROM drive, flash memory, a magnetic tape medium, or the like. Remote storage over a network is also contemplated. One or more of the memory or storage regions may contain programming code capable of configuring the computer system 40 to embody aspects of the present invention. The present invention, thus, encompasses program storage on an appropriate computer-readable medium, such as RAM, ROM, a disk drive, or the like and which is executable by processor 42, thereby to form an exemplary system. The I/O system 43 may operate with various input and output devices, 44 & 45 respectively, such as a keyboard, a display, a pointing device. It may also operate with a data network 46 via a suitable communications link 47. In addition, the I/O system can communicate with a data storage 46 such as a database or the like.

Although certain aspects of a computer system may be preferred in the illustrative embodiments, the present invention should not be unduly limited as to the type of computer on which it runs, and it should be readily understood that the present invention indeed contemplates use in conjunction with any appropriate information processing device, such as a general-purpose PC, a PDA, network device or the like, which has the capability of being configured in a manner for accommodating the invention. Moreover, it should be recognized that the invention could be adapted for use on computers other than general purpose computers, as well as on general purpose computers without conventional operating systems.

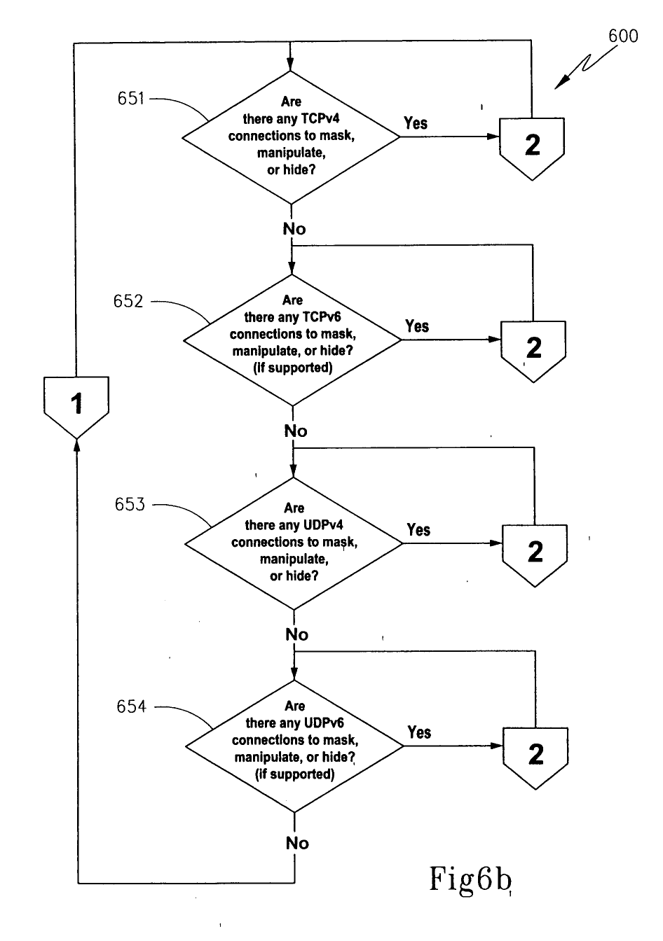

FIG. 5 represents a high level flow diagram 50 for computer software which implements the functions of the new_getmsg LKM 35. According to flow 50, a user space call to getmsg at 52, such as from the netstat utility, causes flow to be redirected to new_getmsg 35 within the kernel. new_getmsg 35 allows the original getmsg to be processed at 54 so that the file descriptor (FD) which is returned by getmsg at 56 can be analyzed. Based on an analysis, as described in greater detail below, a determination is made at 57 whether the file descriptor was derived from a user process, namely netstat in the preferred embodiment, which requested network status information via the getmsg system call. If so, suitable network connection data can be modified at 58 whereupon custom LKM 35 returns modified network connection data to the user space process at 59. If, on the other hand, it is deemed that the file descriptor returned at 56 is not derived from an application such as netstat at 58, then custom LKM 35 simply returns, at 59, values from the original getmsg system call.

As stated above, a working prototype has been coded to achieve aspects discussed herein. In the proof-of-concept code, precompiled settings were used to accomplish the hiding of connection data. As an example, precompiled settings may be used to conceal all TCPv4 connections with a local port of 22, or a local port of 23, and a foreign port of 34052. The code replaces or “hooks” the getmsg system call, and searches deeply into the network data to hide connections. The search is conducted by accessing the vnode of the file descriptor passed to the getmsg system call, and using the associated stream pointer to walk the queues that contain the actual data blocks which contain the appropriate connection data to be masked or hidden. This data could also be accessed by locating either the strrput( ) or putp( ) function of the appropriate stream using the modgetsymvalue( ) kernel function and performing the same deep search into the queue's data blocks to mask or hide the appropriate data. Once the prototype walks through the stream queues to locate the data that needs to be searched for connection information, each data set is examined for connections in each protocol (TCPv4, TCPv6, UDPv4 and UDPv6) which is to be masked or hidden.

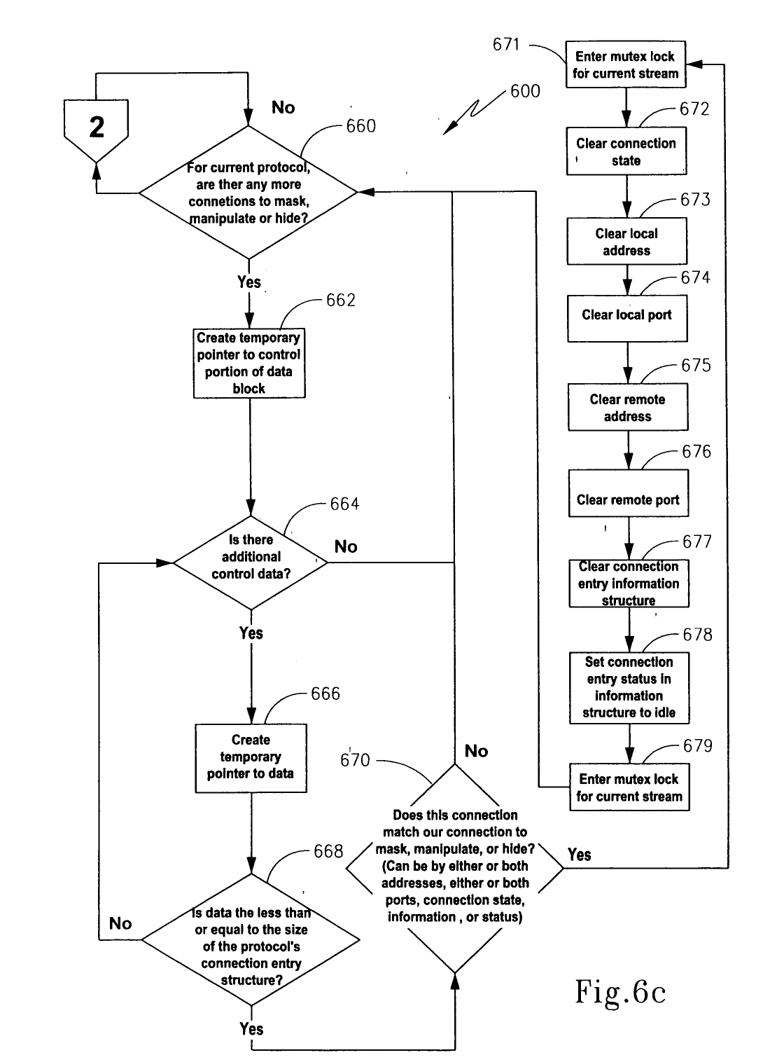

A more detail program flow 600 for accomplishing the above is collectively shown in FIGS. 6(a)-6(c). At 602, process calls for the original getmsg system call are pointed to the replacement system call function, new_getmsg. At 604, a call is made to the original getmsg call function and its return value(s) are saved. At 606, the file descriptor passed to getmsg is used to obtain the associated file structure using the getf( ) function. Presuming this file structure does exist at 608, the vnode pointer is obtained from it at 610. Again, presuming there is a pointer to a vnode structure at 612, a stream head pointer from the vnode structure is obtained at 614. Of course, if there is no corresponding vnode or file structure, either because they do not exist or due to some error, representative program flow 600 simply returns saved value(s) from the original getmsg system call at 601.

Presuming, however, that a stream does exist at 616, a pointer is created at 618 to the read side of the module, at the stream head, from the write queue. If the module's queue's information structure exists at 620, its module identification is checked at 622 to determine if it matches the unique module identifier (i.e. 5607 for Solaris 7 and 5707 for Solaris 8 and 9). If there is no match, but there are more modules in the stream at 624, the pointer is moved to the next module's queue at 626 so that step 620 is repeated for it.

Assuming, however, that there is a module ID match for some module's queue in response to the inquiry at 622, indicating that the stream head of interest has been encountered, flow proceeds at 628 to obtain commonly used sizes for the supported TCP and UDP structures. At 630, an inquiry is made whether there is more data in the queue. If so, a temporary pointer is created to the data at 634. A determination is then made at 636 whether the length of the data block is greater than or equal to a T_OPTMGMT_ACK structure, meaning that the data block is likely an options management acknowledgement, and indicating that an options management request has completed. Thus, at 638, a temporary management structure pointer can be created to the data block.

If the data's primitive type is T_OPTMGMT_ACK at 640, this indicates that the data block is highly likely to be an options management acknowledgement. Also, if the data's management flag is T_SUCCESS at 642, this indicates that the specified acknowledgement is a successful response to an options management request. This is a final verification that the data block is an options management acknowledgement, and indicates data that needs to examined further. A temporary OPTHDR structure pointer is thus created to the data at 644. If, however, the data does not have the correct characteristics at 636, 640 and 642, the temporary pointer is instead moved to the next data block at 646 so that a determination can again be made at 630 as to whether there is any more data in the queue.

Presuming, though, that the data does have the proper characteristics flow 600 proceeds as shown in FIG. 6(b), to make determinations at 651-654 as to whether network connection data from any of the various protocols is to be masked or hidden based on pre-defined settings as discussed above. If there are none, then flow returns to off page reference 1 in FIG. 6(a). Otherwise, for any affirmative response at 651-654, flow 600 proceeds at 660 in FIG. 6(c) to ascertain if there are any additional connections to mask or hide for the current protocol. If so, a temporary pointer is created to the control portion of the queue's data block at 662 and an inquiry is made at 664 as to whether there is any additional control data. If so, a temporary pointer is created to the data at 666. Otherwise, flow returns to 660. At 668, a determination is made whether the data is less than or equal to the size of particular protocol's connection entry structure. Presuming this to be the case, which indicates that the control data is likely to be related to the current protocol, a determination is made at 670 as to whether a match exists between the encountered connection and that which is intended to be masked or hidden. A match can exist based on any one of addresses, ports connection, state information or status.

Assuming a match, flow 600 proceeds at 671 to enter the mutex for the current stream. Various changes can then be made. Namely, the connection state is cleared at 672, the local address is cleared at 673, the local port is cleared at 674, the remote address is cleared at 675, the remote port is cleared at 676, the connection entry information structure is cleared at 677, and its status is set to idle at 678. Setting the status to idle has the result of additionally making the connection appear to be unused to netstat. The mutex lock for the current stream is then exited at 679, and flow 600 then returns to operation 660 whereupon the above processing steps are repeated if necessary.

A prototype has been designed using the GNU Emacs text editor and compiled with the GNU C Compiler (gcc). The software has been written as a standalone Solaris kernel module that can be compiled on Solaris 7, 8, and 9. All design and tests were performed on Sun Microsystems' Solaris 7, 8, and 9 on various Sun Microsystems' SPARCstation and UltraSPARC platforms. The tests were performed electronically on the running hardware. The programming could, of course, be developed using several widely available programming languages with the software component(s) coded as subroutines, sub-systems, or objects depending on the language chosen. In addition, various low-level languages or assembly languages could be used to provide the syntax for organizing the programming instructions so that they are executable in accordance with the description to follow. Thus, the preferred development tools utilized by the inventors should not be interpreted to limit the environment of the present invention.

During experimentation, the prototype worked successfully, hiding all intended data as implemented. More particularly, the prototype was able to locate and conceal the data by local port or by local and remote port pair for TCP connections. The data could be located and masked by any other data available in the data queues, including but not limited to connection state, local or remote address, detail data available regarding the window and queue sizes of the connection, protocol, or network device. It is common, for example, for applications to change the offered window size to allowing more or less data to be transferred per packet. Netstat shows this and also reflects the window size being offered by outside connections. There may be situations where it is desirable to manipulate only this reflected window size to make a connection appear to be “normal”, when in fact the queue sizes have been manipulated to allow for greater bandwidth per transmission. Netstat also reflects the queued number of packets either waiting to be sent or waiting to be processed upon receipt. At times, it may be also be desirable to make an extremely slow or unreliable link appear “normal” by manipulating what netstat shows as the number of packets queued and waiting.

Various advantages of the present invention are noteworthy. As shown in the earlier figures, a unique “hook” or interface is used to manipulate the data by redirecting the getmsg( ) system call to a custom one. This allows for greater portability of the code across the variety of Solaris operating systems, including Solaris 9. This was unavailable with the Job De Haas LKM discussed in the Background section which was, at best, limited to a subset of the Solaris operating systems. The unique identification of stream modules have been identified so that the correct set of data can be manipulate in all Solaris published operating systems since Solaris 7. This is important because it allows the single set of code to function across all versions of these operating systems.

Advantageously also, the present implementation is very modular, allowing robust manipulation of data. By breaking the port hiding queries into separate functions and using macros, a single source code can be extended into each of the Solaris operating systems supported. Also, scripting can be included and configured to automatically detect various hardware and software settings at compile time for the target, allowing developers the ability to easily include suitable code with their software. Organizing the code in separate files with specific functions that can easily be added or modified supports the easy and rapid addition of new features and capabilities.

As stated previously, connection information can be manipulated for TCPv4, TCPv6, UDPv4, and UDPv6 protocols. By identifying the appropriate protocol structures support is provided for the full range of Internet protocols used today. Examples include the mib2_tcp6ConnEntry_t, mib2_udpEntry_t, and mib2_udp6Entry_t structures.

Finally, an increase in granularity is provided by the ability to hide or mask the connections. For example, data for all connections to a specific listening port can be masked or hidden, or data about a single connection from a specific port to a specific port can currently be masked or hidden. This could be readily expanded to include addresses, state information (whether the connection is idle, open, etc), or information regarding the connection. For example, the prototype could easily be extended to maintain a dynamic list of predefined ports to hide, as opposed to a statically compiled port as shown in this implementation.

Software embodying the present invention may be distributed in known manners, such as on computer-readable medium which contains the executable instructions for performing the methodologies discussed herein. Alternatively, the software may be distributed over an appropriate communications interface so that it can be installed on the user's computer system. Furthermore, alternate embodiments which implement the invention in hardware, firmware or a combination of both hardware and firmware, as well as distributing the modules and/or the data in a different fashion will be apparent to those skilled in the art. It should, thus, be understood that the description herein is intended to be illustrative and not restrictive, and that many other embodiments will be apparent to those of skill in the art upon reviewing the description.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

What is claimed is:

1. A method, for use on a computer running a Solaris operating system and utilizing a STREAMS sub-system, to selectively manipulate presentation of network connection data when requested by a user space application, said method comprising, in response to a getmsg system call from the user space application:
a. processing the getmsg system call;
b. retrieving a file descriptor returned by the getmsg system call;
c. determining whether said file descriptor corresponds to a device which uses a stream head; and
d. upon determining that said file descriptor does correspond to a device which uses a stream head:
i. analyzing queues within the stream head to ascertain whether any encountered queue relates to a stream module of interest, as identified by a unique module identifier; and
ii. upon ascertaining that an encountered queue within the stream head does relate to the stream module of interest:
(a) modifying selected data within the encountered queue corresponding to network connection characteristics of the computer system, thereby to produce modified network connection data; and
(b) passing the modified network connection data to the user space application.

2. A method according to claim 1 whereby the Solaris operating system is one of Solaris 2.7, 2.8 and 2.9.

3. A method according to claim 1 whereby the Solaris operating system is Solaris 2.7 and the unique module identifier is 5607.

4. A method according to claim 1 whereby the unique module identifier is 5707.

5. A method according to claim 4 whereby the Solaris operating system is Solaris 2.8.

6. A method according to claim 4 whereby the Solaris operating system is Solaris 2.9.

7. A method according to claim 1 whereby the file descriptor is deemed to correspond to a device which uses a stream head upon making a determination that the file descriptor's associated file structure has a vnode object which points to the stream head.

8. A method according to claim 1 whereby the Solaris operating system is Solaris 2.7, and comprising sequentially analyzing read queues within the stream head to ascertain whether any encountered read queue has an associated information structure which contains a module identifier corresponding to 5607.

9. A method according to claim 1 whereby the Solaris operating system is one of Solaris 2.8 and Solaris 2.9, and comprising sequentially analyzing read queues within the stream head to ascertain whether any encountered read queue has an associated information structure which contains a module identifier corresponding to 5607.

10. A method according to claim 1 whereby modifying selected data within the encountered queue is accomplished by clearing network connection information for a plurality of data fields within the encountered queue's information structure.

11. A method according to claim 10 whereby said data fields are selected from a group consisting of a connection state data field, a local address data field, a remote address data field, a local port data field, and a remote port data field.

12. A method according to claim 10 whereby modifying selected data within the encountered queue includes setting connection entry status within the encountered queue's information structure to an idle state.

13. A method according to claim 1 whereby said computer is adapted to communicate according to a plurality of network communication protocols.

14. A method according to claim 13 whereby said network communication protocols are selected from TCPv4, TCPv6, UDPv4 and UDPv6.

15. A computerized method, for implementation on a computer running a Solaris operating system, to control presentation of network connection data when requested by a user space application, said computerized method comprising:
a. determining, for each respective getmsg system call that is processed by the operating system, whether the respective getmsg system call pertains to a selected stream module of interest; and
b. selectively modifying data fields corresponding to network connection characteristics of the computer system upon a determination that the respective getmsg system call does pertain to the stream module of interest, thereby to produce modified network connection; and
c. passing the modified network connection data to the user space application.

16. A computerized method according to claim 15 whereby the Solaris operating system is selected from one of Solaris 2.7, 2.8 and 2.9 and whereby the stream module of interest has a unique module identifier selected from one of 5607 and 5707.

17. A computerized method according to claim 15 whereby said data fields are selected from a group consisting of a connection state data field, a local address data field, a remote address data field, a local port data field, and a remote port data field.

18. A computerized method according to claim 17 comprising setting a connection entry status for the computer system to an idle state.

19. A computerized method, for implementation on a computer running a Solaris operating system, to control presentation of network connection data when requested by an associated user space application, said computerized method comprising:
a. identifying a responsible system call function within the operating system that is called by the associated user space application to retrieve network connection data;
b. determining, each time said system call function is processed by the operating system, whether there is an associated stream module of interest which contains unmodified network connection data characteristic of the computer's network connection status;
c. upon making a determination that there is an associated stream module of interest, selectively altering the unmodified network connection data to produce modified network connection data; and
d. passing the modified network connection data to the associated user space application.

20. A computerized method according to claim 19 whereby the responsible system call function is getmsg.

21. A computerized method according to claim 20 whereby the associated user space application is netstat.

22. A computerized method according to claim 21 whereby the Solaris operating system is selected from one of Solaris 2.7, 2.8 and 2.9 and whereby the stream module of interest has a unique module identifier selected from one of 5607 and 5707.

23. A computerized method according to claim 19 whereby the Solaris operating system is selected from one of Solaris 2.7, 2.8 and 2.9 and whereby the stream module of interest has a unique module identifier selected from one of 5607 and 5707.

24. A computer-readable medium for use on a computer running a Solaris operating system and utilizing a STREAMS sub-system, to selectively manipulate the presentation of network connection data when requested by a user space application, said computer-readable medium comprising:
a. a loadable kernel module having executable instructions for performing a method comprising:
i. determining, for each respective getmsg system call that is processed by the operating system, whether the respective getmsg system call pertains to a selected stream module of interest; and
ii. selectively modifying data fields corresponding to network connection characteristics of the computer system when a determination is made that the respective getmsg system call pertains to the selected stream module of interest, thereby to produce modified network connection data; and
iii. passing the modified network connection data to the user space application.

25. A computer readable medium according to claim 24 whereby the Solaris operating system is selected from one of Solaris 2.7, 2.8 and 2.9 and whereby the stream module of interest has a unique module identifier selected from one of 5607 and 5707.

26. A computer readable medium according to claim 25 whereby said data fields are selected from a group consisting of a connection state data field, a local address data field, a remote address data field, a local port data field, and a remote port data field, and comprising setting a connection entry status for the computer system to an idle state.

27. A method, for use on a computer running a Solaris operating system operating system utilizing a STREAMS sub-system, to selectively manipulate the presentation of network connection data when requested by a user space application, said method comprising:
a. loading, into the operating system's kernel, a kernel module having executable instructions for performing a method comprising:
i. determining, for each respective getmsg system call that is processed by the operating system, whether the respective getmsg system call pertains to a selected stream module of interest; and
ii. selectively modifying data corresponding to network connection characteristics of the computer system when a determination is made that the respective getmsg system call pertains to the selected stream module of interest, thereby to produce modified network connection data; and
iii. passing the modified network connection data to the user space application; and
b. modifying the operating system's system call table to re-direct each system call intended for getmsg to said kernel module.

28. A computerized method according to claim 27 whereby the Solaris operating system is selected from one of Solaris 2.7, 2.8 and 2.9 and whereby the stream module of interest has a unique module identifier selected from one of 5607 and 5707.

29. A computerized method according to claim 28 whereby said data fields are selected from a group consisting of a connection state data field, a local address data field, a remote address data field, a local port data field, and a remote port data field.

30. A computerized method according to claim 28 comprising setting a connection entry status for the computer system to an idle state.

31. A system for selectively manipulating presentation of network connection data when requested by a netstat utility, comprising:
a. a storage device;
b. a Solaris operating system of a selected kernel version which utilizes a STREAMS sub-system and which supports getmsg system calls;
c. a processor programmed to:
i. determine, for each respective getmsg system call that is processed by the operating system, whether the respective getmsg system call pertains to a selected stream module of interest; and
ii. selectively modify data fields corresponding to network connection characteristics of the computer system upon determining that the respective getmsg system call does pertain to the selected stream module of interest, thereby to produce modified network connection data; and
iii. pass the modified network connection data to the user space application; and
d. an output device for presenting said modified connection data.

32. A computerized method according to claim 31 whereby the kernel version is selected from one of Solaris 2.7, 2.8 and 2.9 and whereby the stream module of interest has a unique module identifier selected from one of 5607 and 5707.

33. A computerized method according to claim 31 whereby said data fields are selected from a group consisting of a connection state data field, a local address data field, a remote address data field, a local port data field, and a remote port data field.

34. A computerized method according to claim 33 comprising setting a connection entry status for the computer system to an idle state.
